(19) United States
(12) Patent Application Publication
(10) Pub. No.: US 2014/0286612 A1
(43) Pub. Date: Sep. 25, 2014

(54) COUPLING DEVICE

(71) Applicant: ALL BEST PRECISION TECHNOLOGY CO., LTD., Taoyuan County (TW)

(72) Inventor: HAVEN YANG, New Taipei City (TW)

(73) Assignee: ALL BEST PRECISION TECHNOLOGY CO., LTD., Taoyuan County (TW)

(21) Appl. No.: 13/847,699

(22) Filed: Mar. 20, 2013

(51) Int. Cl. G02B 6/36

(52) U.S. Cl. CPC G02B 6/3628
USPC 385/88

(57) ABSTRACT

A coupling device couples a light guiding unit and a base board together. The coupling device includes a base and a lens unit. The base has a hole for receiving the light guiding unit. After an end of the light guiding unit has been inserted into an end of the hole, the end of the light guiding unit is guided through the hole toward the base board. The lens unit is positioned proximate to another end of the hole and adapted to focus a first light exiting the light guiding unit onto the base board, and/or focus a second light exiting the base board onto the light guiding unit. Therefore, the coupling device is easy to manufacture, precludes attenuation the propagating first and second lights, and enhances the quality of signal transmission.

### FIELD OF THE INVENTION

The present invention relates to coupling devices, and more particularly, to a coupling device whereby a light guiding unit is coupled to a base board.

### BACKGROUND OF THE INVENTION

According to the prior art, long-distance digital data transmission can be carried out by means of an optical fiber-based communication system, wherein the digital data is generated from an electronic apparatus. To transmit the digital data with the optical fiber, it is necessary to perform photoelectrical modulation on the digital data to thereby turn the digital data into a light ray and then transmit the light ray with the optical fiber.

The electronic apparatus can process the digital data in electrical form only. Hence, after the light ray has been transmitted with the optical fiber, the light ray has to undergo photoelectrical modulation in order to be turned into the digital data again, such that the resultant digital data can be processed by the electronic apparatus.

According to the prior art, a waveguide structure enables a light ray exiting one end of the optical fiber (wherein the one end of the optical fiber is coupled to the electronic apparatus) to change its course, by reflection or refraction, such that the light ray enters the electronic apparatus eventually. Conversely, the waveguide structure enables a light ray exiting the electronic apparatus to change its course and thus enter the optical fiber eventually.

However, the intensity of the light ray attenuates, because of the materials of which the waveguide structure is made and the coarse surface of the waveguide structure. Persons skilled in the art understand that the quality of signal transmission of the optical fiber-based communication system depends on the intensity of light rays.

Accordingly, it is imperative to put forth a coupling device that overcomes drawbacks of the prior art.

### SUMMARY OF THE INVENTION

It is an objective of the present invention to provide a coupling device comprising a base and a light guiding unit (such as an optical fiber or a waveguide pipe), such that a hole of the base extends in a specific direction to thereby change another direction in which one end of the light guiding unit extends toward a base board, and in consequence a first light exiting the light guiding unit enters the base board, and/or the light guiding unit receives a second light from the base board.

Another objective of the present invention is to provide a coupling device which has a lens unit disposed between the light guiding unit and the base board and adapted to focus the first light and the second light.

Yet another objective of the present invention is to provide a coupling device characterized in that the hole comprises a first hole portion and a second hole portion, wherein the diameter of the first hole portion is larger than the diameter of the second hole portion. An annular body features a guide angle and is connected between the first hole portion and the second hole portion, such that the light guiding unit can be guided from the first hole portion to the second hole portion via the annular body.

In order to achieve the above and other objectives, the present invention provides a coupling device characterized in that a light guiding unit is coupled to a base board. The coupling device comprises a base and a lens unit. The base has a hole. The hole receives the light guiding unit. After an end the light guiding unit has been inserted into one end of the hole, the end of the light guiding unit is guided through the hole toward the base board. The lens unit is positioned proximate to the other end of the hole and adapted to focus the first light from the light guiding unit, such that the focused first light falls on the base board. The second light from the base board is focused by the lens unit, such that the focused second light enters the light guiding unit.

Compared with the prior art, the present invention provides a coupling device characterized by a light guiding unit with one end bent by means of a hole, such that the bent end of the light guiding unit is guided through the hole toward a base board, and in consequence the light guiding unit and the base board can be coupled together. After the light guiding unit and the base board have been coupled together, the first light from the light guiding unit falls on a light receiver (such as a photodiode) mounted on the base board. The bent end of the light guiding unit receives the second light emitted from a light emitter (such as a laser diode) mounted on the base board. The coupling device of the present invention enables the light guiding unit to be coupled directly to the base board, and thus attenuation does not occur to the first light and the second light in the course of propagation thereof.

The present invention is further characterized in that the coupling device enables the light guiding unit to be coupled directly to the base board without a waveguide structure disclosed in the prior art and adapted to couple the light guiding unit and the base board together. Hence, compared with the prior art, the present invention simplifies the manufacturing process of the coupling device.

### BRIEF DESCRIPTION OF THE DRAWINGS

Objectives, features, and advantages of the present invention are hereunder illustrated with specific embodiments in conjunction with the accompanying drawings, in which:

FIG. 1 is a structural schematic view of a coupling device according to an embodiment of the present invention;

FIG. 2 is a cross-sectional view of the coupling device taken along line A-A′ in FIG. 1;

FIG. 3 is a structural schematic view of a first hole of the coupling device according to the first embodiment of the present invention;

FIG. 4 is a structural schematic view of a first hole of the coupling device according to the second embodiment of the present invention;

FIG. 5 is a structural schematic view of a base of the coupling device according to the first embodiment of the present invention;

FIG. 6 is a structural schematic view of a base of the coupling device according to the second embodiment of the present invention; and

FIG. 7 is a structural schematic view of a base of the coupling device according to the third embodiment of the present invention.

### DETAILED DESCRIPTION OF THE PREFERRED EMBODIMENTS

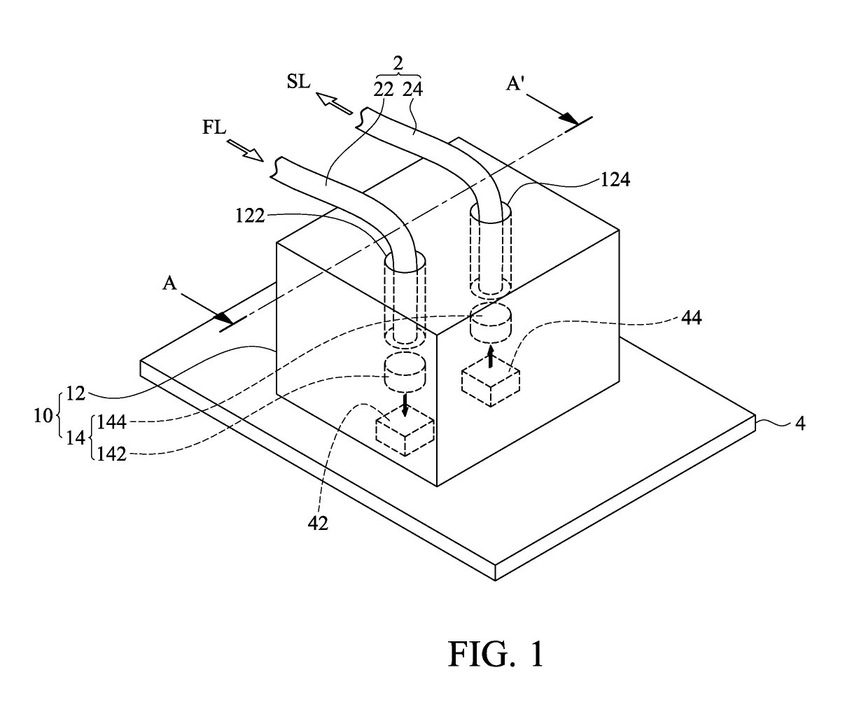

Referring to FIG. 1, there is shown a structural schematic view of a coupling device 10 according to an embodiment of the present invention. As shown in FIG. 1, the coupling device 10 enables a light guiding unit 2 to be coupled to a base board 4. The base board 4 is panel-shaped. In this embodiment, the light guiding unit 2 comprises a first optical fiber 22 and a second optical fiber 24. A first light FL emitted from a remote end (not shown) is transmitted, in the direction indicated by the arrow shown in FIG. 1, by the first optical fiber 22 to the base board 4. A second light SL emitted from the base board 4 is transmitted, in the direction indicated by the arrow shown in FIG. 1, by the second optical fiber 24 to the remote end. The base board 4 comprises a light receiver 42 and a light emitter 44. The light receiver 42 receives the first light FL. The light emitter 44 emits the second light SL.

The coupling device 10 comprises a base 12 and a lens unit 14.

The base 12 has a first hole 122 and a second hole 124. The base 12 is made of a transparent or translucent material. The first hole 122 and the second hole 124 are a blind via hole each. The blind via hole comprises an open end, a receiving portion, and a closed end. The receiving portion is exposed through the open end and closed at the closed end. Although this embodiment is exemplified by the first hole 122 and the second hole 124, other embodiments are exemplified by a single hole or at least two holes. The receiving portion of the first hole 122 receives one end of the first optical fiber 22. The receiving portion of the second hole 124 receives one end of the second optical fiber 24.

Referring to FIG. 1, the first hole 122 and the second hole 124 are perpendicular to the base board 4. After being inserted into the open end of the first hole 122, the end of the first optical fiber 22 is guided along the receiving portion of the first hole 122 to reach the light receiver 42; hence, when received in the receiving portion of the first hole 122, the end of the first optical fiber 22 is perpendicular to the base board 4. After being inserted into the open end of the second hole 124, the end of the second optical fiber 24 is guided along the receiving portion of the second hole 124 to reach the light emitter 44; hence, when received in the receiving portion of the second hole 124, the end of the second optical fiber 24 is perpendicular to the base board 4.

The lens unit 14 is provided in the form of two lenses, namely a first lens 142 and a second lens 144. The first lens 142 is positioned proximate to the closed end of the first hole 122. The second lens 144 is positioned proximate to the closed end of the second hole 124. Since the base 12 is made of a transparent or translucent material, the first light FL which exits the closed end of the first hole 122 passes through the base 12 to enter the first lens 142, whereas the second light SL which exits the second lens 144 passes through the base 12 to enter the closed end of the second hole 124.

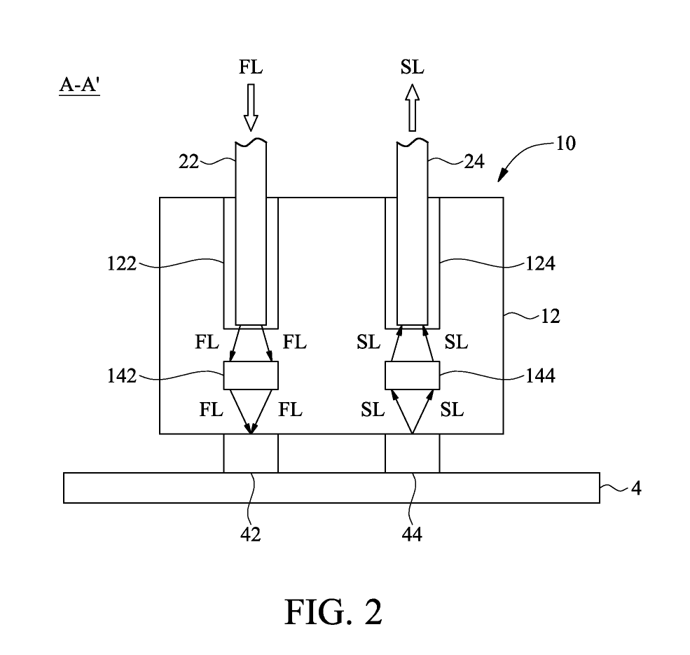

Referring to FIG. 2, there is shown a cross-sectional view of the coupling device 10 taken along line A-A′ in FIG. 1. As shown in FIG. 2, the first light FL is focused fully onto the light receiver 42 by means of the first lens 142 without attenuation, whereas the second light SL is focused fully onto the second optical fiber 24 by means of the second lens 144 without attenuation, to thereby ensure high-quality signal transmission.

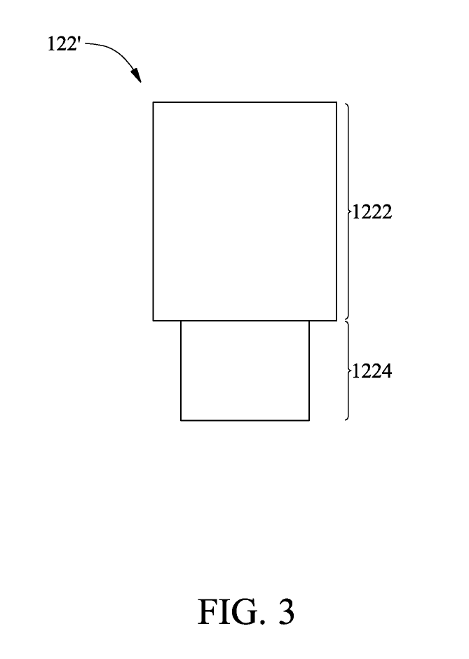

Referring to FIG. 3, there is shown a structural schematic view of a first hole 122′ according to the first embodiment of the present invention. As shown in FIG. 3, the first hole 122′ comprises a first hole portion 1222 and a second hole portion 1224. The diameter of the first hole portion 1222 is larger than the diameter of the second hole portion 1224.

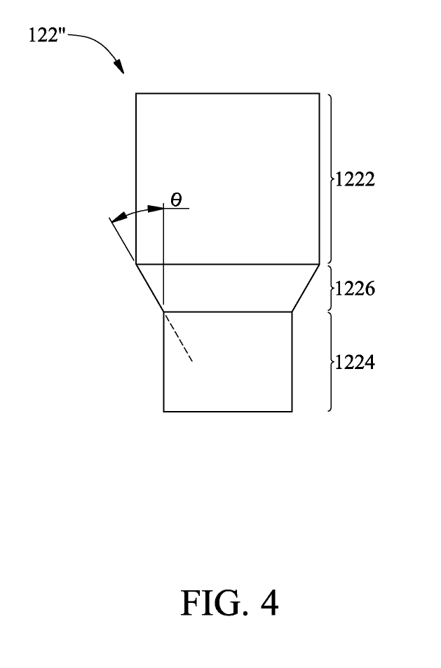

Referring to FIG. 4, there is shown a structural schematic view of a first hole 122″ according to the second embodiment of the present invention. As shown in FIG. 4, the first hole 122″ comprises a first hole portion 1222, a second hole portion 1224, and an annular body 1226. The diameter of the first hole portion 1222 is larger than the diameter of the second hole portion 1224. The annular body 1226 is connected between the first hole portion 1222 and the second hole portion 1224. A guide angle θ is defined as the included angle between the slope of the annular body 1226 and the inner wall of the first hole portion 1222 (or the second hole portion 1224) and is less than 90°.

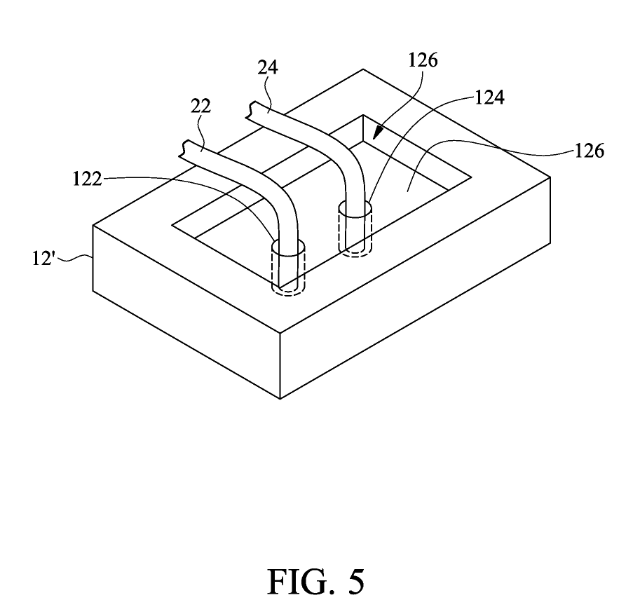

Referring to FIG. 5, there is shown a structural schematic view of a base 12′ according to the first embodiment of the present invention. As shown in FIG. 5, the base 12′ comprises a recess 126. The recess 126 is disposed above the first hole 122 and the second hole 124 and adapted to receive the first optical fiber 22 and the second optical fiber 24.

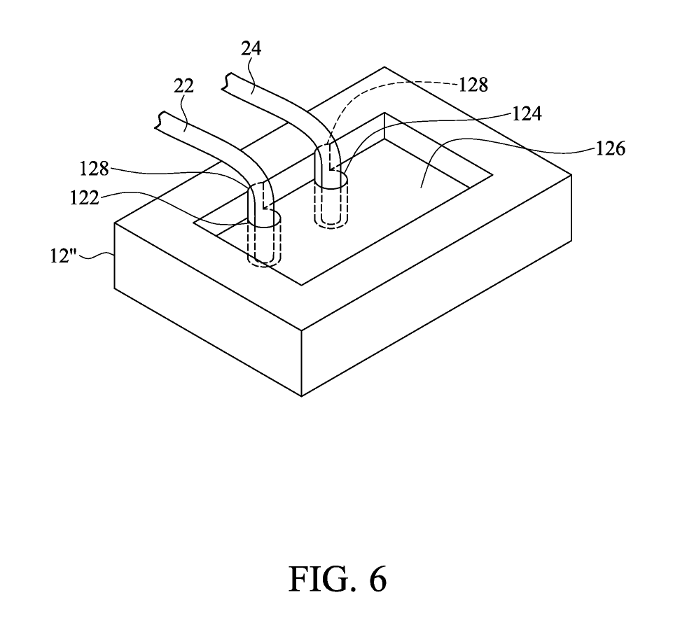

Referring to FIG. 6, there is shown a structural schematic view of a base 12″ according to the second embodiment of the present invention. As shown in FIG. 6, the base 12″ comprises the recess 126 and guide grooves 128. The recess 126 is illustrated with FIG. 6 in the same way as it is with FIG. 5. The guide grooves 128 are disposed on the inner wall of the recess 126, such that the first optical fiber 22 and the second optical fiber 24 are guided to the first hole 122 and the second hole 124 by means of the guide grooves 128, respectively. In this embodiment, the guide grooves 128 are disposed on the same inner wall of the recess 126; however, in another embodiment, the guide grooves 128 are disposed on different inner walls of the recess 126, respectively.

Referring to both FIG. 5 and FIG. 6, the recess 126 can be filled with a glue (not shown) whereby the first optical fiber 22 and the second optical fiber 24 are fixed to the recess 126.

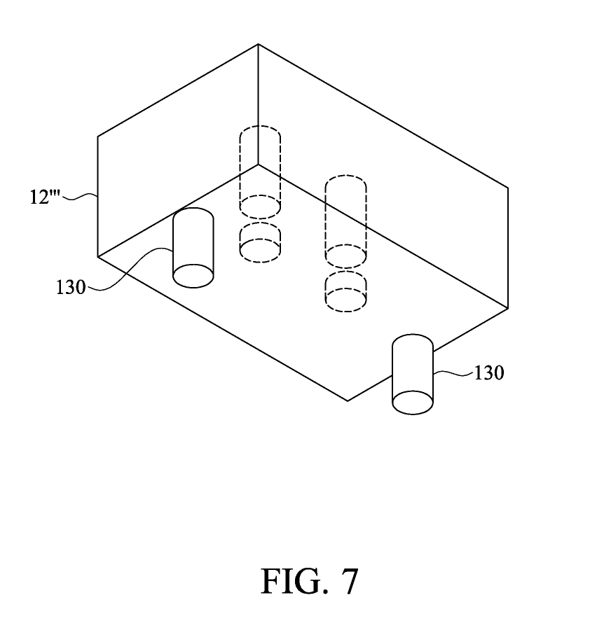

Referring to FIG. 7, there is shown a structural schematic view of a base 12′″ according to the third embodiment of the present invention. As shown in FIG. 7, the base 12′″ comprises positioning units 130, and the positioning units 130 are provided in the form of positioning posts. This embodiment is exemplified by two said positioning units 130. Assuming that the base board 4 has two positioning holes (not shown), the positioning units 130 would correspond in position to the two positioning holes, respectively. Once the positioning units 130 are coupled to the two positioning holes, respectively, the base 12′″ is firmly fixed to the base board 4.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A coupling device for coupling a light guiding unit and a base board together, the coupling device comprising:
a base having a hole for receiving the light guiding unit, wherein, after an end of the light guiding unit has been inserted into an end of the hole, the end of the light guiding unit is guided through the hole toward the base board; and
a lens unit positioned proximate to another end of the hole and adapted to focus a first light exiting the light guiding unit onto the base board, and/or focus a second light exiting the base board onto the light guiding unit.

2. The coupling device of claim 1, wherein the hole comprises a first hole portion and a second hole portion, and a diameter of the first hole portion is larger than a diameter of the second hole portion.

3. The coupling device of claim 2, wherein an annular body characterized by a guide angle is disposed between the first hole portion and the second hole portion.

4. The coupling device of claim 3, wherein the guide angle is less than 90°.

5. The coupling device of claim 1, wherein the base comprises a recess disposed above the hole and adapted to receive the light guiding unit.

6. The coupling device of claim 5, further comprising guide grooves disposed on at least an inner wall of the recess and adapted to guide the light guiding unit to the hole.

7. The coupling device of claim 5, wherein the base is made of a transparent or translucent material.

8. The coupling device of claim 7, wherein the hole is a blind via hole.

9. The coupling device of claim 5, further comprising a glue disposed in the recess and adapted to fix the light guiding unit to the recess.

10. The coupling device of claim 1, wherein the base further comprises positioning units for coupling the base and the base board together.
